(19) United States
(12) Patent Application Publication
(10) Pub. No.: US 2003/0065787 A1
(43) Pub. Date: Apr. 3, 2003

(54) Method to provide data communication service

(75) Inventors: Tatsuaki Osafune, Kawasaki (JP); Katsuyoshi Kitai, Inagi (JP); Haruo Shibata, Yokohama (JP); Koji Tanaka, Yokohama (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/066,756

(22) Filed: Feb. 6, 2002

(30) Foreign Application Priority Data
Sep. 28, 2001 (JP) 2001-298914

(51) Int. Cl. G06F 15/16

(52) U.S. Cl. 709/227

(57) ABSTRACT

A method to provide data communication service, which enables each service provider to provide each user with both contents service and Internet connection service. The method provides an Internet service provider with an AT-GW 341 used to authenticate the user, hold a network address assigned to the user, and translate a network address, which is different from a network address held by the user, thereby establishing communication between the user computer and the Internet service provider. The configuration of the present invention thus enables the user to receive high quality contents service and Internet connection service provided from a communication enterprise concurrently.

### BACKGROUND OF THE INVENTION

The present invention relates to a method to provide data communication service, more particularly to a method to provide the data service as supply of contents to users via telecommunication carriers, as well as Internet connection services via ISPs.

In recent years, data communication service represented by Internet connection services are rapidly becoming popular. A user who wants to receive such an Internet connection service is required first to contract with a communication enterprise that provides the user with a communication line connected to both of a wired/wireless access line and an ISP (Internet Service Provider) and with an ISP that provides the user with a communication line connected to a mutual connection point referred to as an IX (Internet exchange) on the Internet. Usually, the communication enterprise and the ISP are different. In the viewpoint of the communication enterprise, plural users and plural ISPs are connected to the network of the communication enterprise so that a user's request of a connection to an ISP is distributed correctly to the requested ISP, thereby the user can receive the desired data communication service therefrom.

There are conventional data communication service as described in Nikkei Communication (2, 19, 2001, p116-123) FIG. 1 shows a method for those services.

In FIG. 1, a user home 101 is connected to a local switching center 102 of a communication enterprise via an optical fiber line. The local switching center 102 connects ISP-A 104 and ISP-B 105 via a local IP (Internet Protocol) network 103 respectively. Both ISP-A 104 and ISP-B 105 are connected to the Internet 106 respectively. A PC (Personal Computer) 111 is installed at the user home 101. The PC 111 is connected to a PPPoE (PPP over Ethernet) router 112. The PPPOE router 112 is a terminator of the optical fiber line led at the user home 101. The router 112 is also connected to an ONU (Optical Network Unit) 113 used to translate signals between electric signals and optical signals. In addition, an OLT (Optical Line Terminal) 121 used to terminate the optical fiber line and translate signals between electric signals and optical signals and a BAS (Broadband Access Server) 122 in the local switching center 102. An ISP connection control equipment 131 is installed in the local IP network 103. And, an authentication server 141 is installed in the ISP-A 104 and an authentication server 151 is installed in the ISP-B 105.

When a user connects the Internet from the PC 101, the processing is done in the following sequence. At first, the user is requested to enter the user name, the domain name, and the password to the PPPoE router 112, thereby the communication is started between the BAS 122 and the PPPOE via the ONU 113 and the OLP 121. The BAS 122 terminates the PPPoE and decides the address of the user-specified connection from the domain name by using the ISP connection control equipment 131. When the destination ISP is decided, the user authentication is done in the ISP authentication server 141 or 151 according to the user name and the password. When the user is authenticated, the PPPoE gets the IP address distributed from the authentication server 141 or 151. Hereinafter that IP address is used for the communication to be done via the ISP.

When a PPPoE software program is installed in the PC 111, the PC can be connected to the ONU 113 directly not via the PPPoE router 112. In this case, the PC 111 gets the IP address distributed from the ISP.

FIG. 2 shows how the user connects the ISP 203 via a PSTN (Public Switched Telephone Network) 202 of a communication enterprise from his/her home 201, thereby beginning communication on the Internet. The PC 111 installed at the user home 201 is connected to a modem 212 used to modulate/demodulate communication signals. A RAS (Remote Authentication Server) 231, an authentication server 232, and a NAT (Network Address Translator) 233 are installed in the ISP 203.

When the user connects the Internet, the PC 211 begins communication with the RAS 231 by using the PPP (Point-to-Point Protocol) via the modem 212. At this time, the user name and the password of the user are sent to the RAS 231 from the PC 211. The RAS 231 then sends the user name and the password to the authentication server 232. When the user is authenticated, the authentication server 232 distributes a private address to the PC 211 via the RAS 231, thereby completing the PPP connection. When the PC 211 communicates with the Internet 204, the PC 211 sends a packet of the distributed private address to the ISP 203 as the source IP address. The NAT 233 in the ISP 203 translates the source IP address to a global address, thereby enabling the communication with the Internet. In particular, in order to reduce the number of IP addresses to be held in the ISP 203, a technique referred to as the NAPT (Network Address Port Translation) is used to translate source port numbers of the TCP (Transmission Control Protocol).

### SUMMARY OF THE INVENTION

In the two data communication services, a communication enterprise provides such communication lines as a local switching center, a local IP network, a PSTN, etc. so as to enable ISPs different from this communication enterprise to provide Internet connection services.

However, those conventional methods for providing data communication services have not avoided a problem that every communication enterprise must connect the Internet while the users use the line of the communication enterprise so as to provide its users with such data supply services as contents supply services.

Under such circumstances, it is an object of the present invention to provide a method for providing data communication services by connecting a user computer to an Internet service provider via a network and establishing the communication between the user computer and the Internet service provider. According to this method, the user computer holds a first network address assigned thereto from the Internet provider and translates a second network address, which is different from the first one, to a first network address, thereby establishing the communication between the user computer and the Internet service provider. The second network address is assigned to the user computer from the network. The network holds the user ID used to identify the user computer and the second network address that are related to each other. When the user computer accesses a server in the network, this second network address may be used. When the user computer is enabled to access the Internet service provider, the network asks the Internet service provider to authenticate the user and uses the first network address assigned to the user computer from the Internet service provider.

The user computer may be provided with a function that stores the user ID, the first network address, the second network address so as to be related to each other. This function may also be used to translate the first and second addresses easily and automatically, thereby the user computer is enabled to access the server in the network and access the Internet via the Internet service provider in a seamless manner.

Those functions may be installed in any place in the network. The functions can be realized with the following configuration formed in the network. Concretely, the configuration includes user identifying information used to identify the user computer, an address translation gateway provided with a table that holds a pair of a private address assigned to the user computer from the network and a global address assigned to the user computer from the service provider, an access server that requests the address translation gateway for a private address in response to the user identifying information and the password received from the user computer, etc.

The functions can also be realized by an address translator connected to plural user computers and plural Internet service providers via a network and enabled to communicate with an authentication server installed in the network of an Internet service provider to authenticate a user when a connection request is issued from a user computer to an Internet service provider, store the network address assigned to the user computer, translate both source and destination network addresses described in the corresponding field of a communication packet, then transfer the translated addresses. The address translator also holds a pair of a network address assigned to each user computer and a network address assigned to the user computer from the Internet service provider when the user computer issues a connection request. The address translator, when receiving a packet in which the network address described in the held pair, translates the address to the other network address described in the held pair, then outputs the translated address to the network line.

### BRIEF DESCRIPTION OF THE DRAWINGS

FIG. 1 is a block diagram of a conventional system described in Nikkei Communication (2,19,2001);

FIG. 2 is a block diagram of a conventional system for providing Internet connection services by using private addresses;

FIG. 3 is a block diagram of a data communication service providing system in an embodiment of the present invention;

FIG. 4 is a flowchart of a sequence executed at the initialization of a data communication service in the embodiment of the present invention;

FIG. 5 is an address translation table held by an AT-GW at the time of initial connection by the user;

FIG. 6 is a flowchart of a communication sequence for a user to receive a local service so as to connect the Internet;

FIG. 7 is a flowchart of a communication sequence for the user to connect the Internet;

FIG. 8 is a user contract information table held in a user management server;

FIG. 9 is an address translation table held by an AT-GW, used by the user to connect the Internet;

FIG. 10 is a flowchart executed when the user cannot connect the Internet;

FIG. 11 is a flowchart for the user to communicate with a portal server so as to contract with an ISP and connect the ISP;

FIG. 12 is a top view of a screen displayed for making an ISP contract and an ISP connection of the user via the communication with the portal server;

FIG. 13 is a flowchart of a communication sequence for the user to disconnect the ISP at an AT-GW;

FIG. 14 is a functional block diagram of an function block of the AT-GW of the present invention, realized by a software program on a server;

FIG. 15 is a functional block diagram of an AT-GW address translation function of the present invention, realized with hardware; and

FIG. 16 is a functional block diagram of a portal server functional block, realized by a software program held on a server.

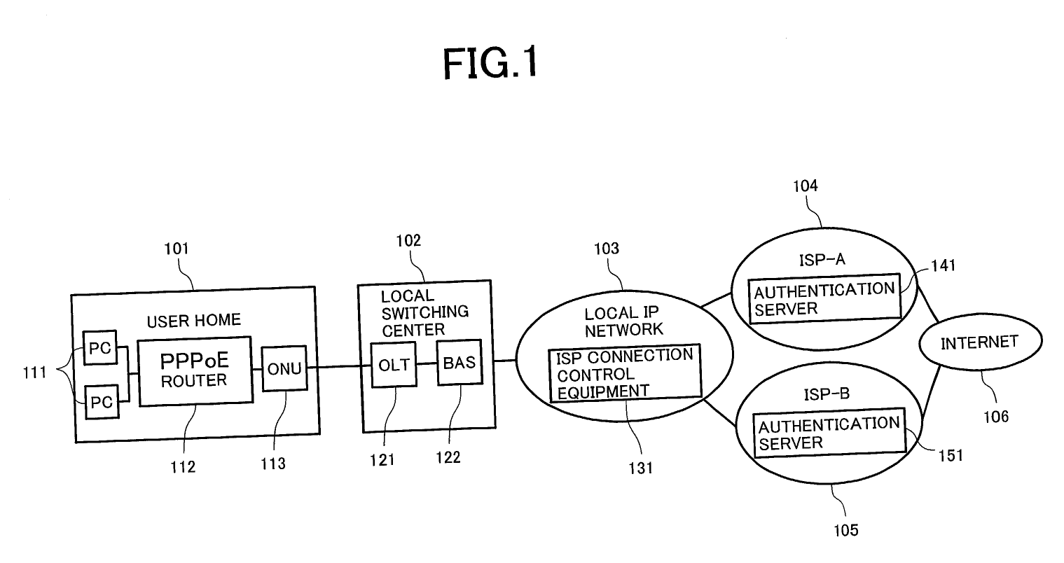

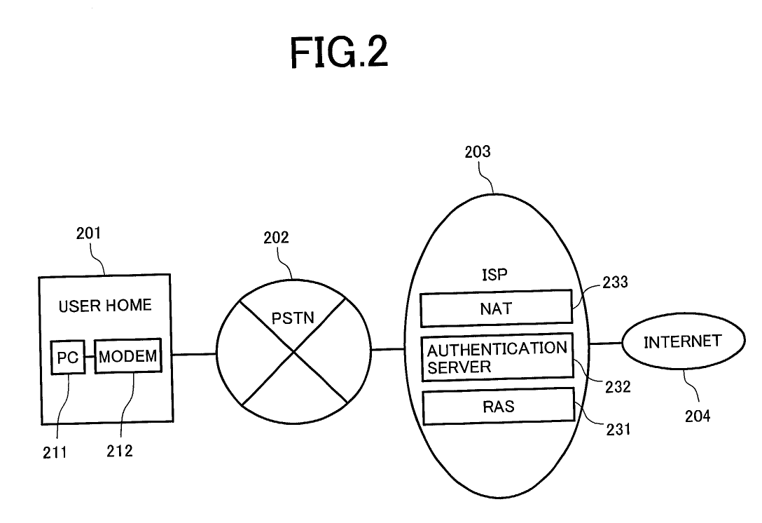

### DETAILED DESCRIPTION OF THE PREFERRED EMBODIMENTS

Hereunder, a preferred embodiment of the present invention will be described with reference to the accompanying drawings.

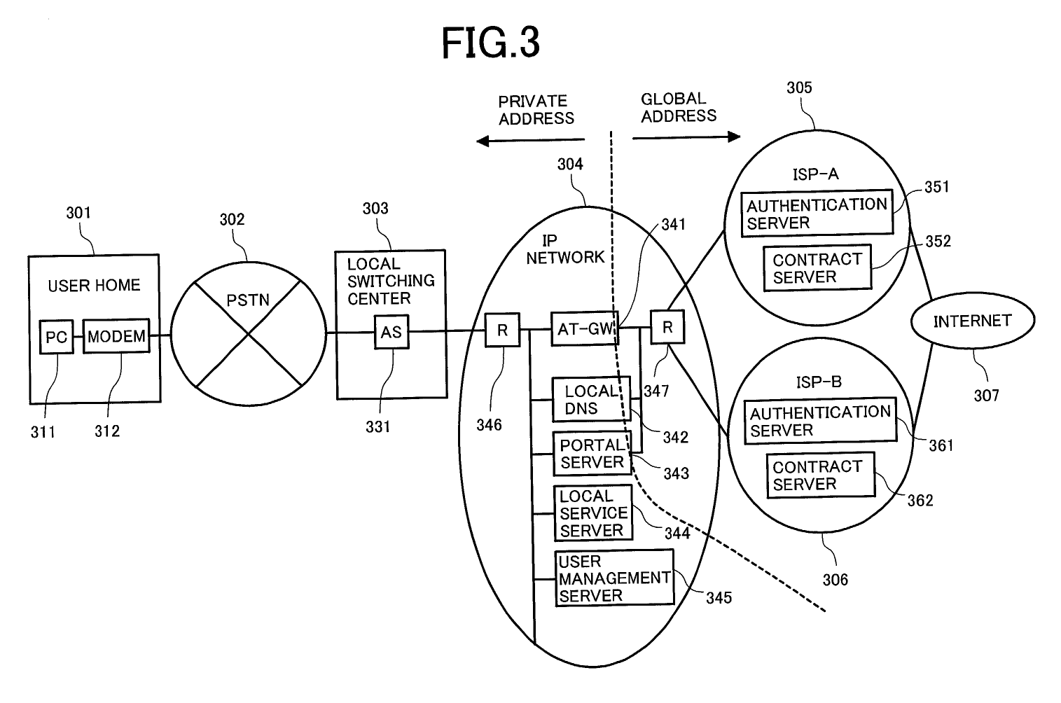

FIG. 3 shows a block diagram of a method for providing data communication services in an embodiment of the present invention. In FIG. 3, a user home 301 connects a local switching center 303 via a PSTN 302. A PC 311 installed at the user home 301 connects a modem 312, thereby communicating with a local access server (AS) 331 provided in the local switching center 303. The local switching center 303 is connected to an ISP-A 305 and an ISP-B 306 that are ISPs via an IP network 304. The ISP-A 305 and the ISP-B 306 are connected to the Internet so that they can provide the user with an Internet connection service. In the IP network 304, an address translation gateway (AT-GW) 341 used to translate a private address assigned to the user to an IP address assigned from an ISP, a local DNS server 342 used to accept name solution queries from users, a portal server 343 that is a web server used to display information required when the user selects an ISP; a local service server 344 used by the communication enterprise to provide its users with contents inside its own network not via the Internet; and a user management server 345 used to hold ISP contract information of each user are installed. Each of the servers are connected to the local switching center 303 via a router 346. A private address is assigned to an interface used to connect each of the servers to a router 346. The AT-GW 341, the local DNS 342, and the portal server 343 are connected to the ISP-A 305 and the ISP-B 306 respectively via a router 347 that uses an interface that is different from the private address assigned one. A global address is assigned to this interface connected to the router 347.

In the ISP-A 305 are installed an authentication server 351 used to authenticate each user and a contract server 352 used to accept a contract of each user. In the same way, an authentication server 361 and a contract server 362 are installed in the ISP-B 306.

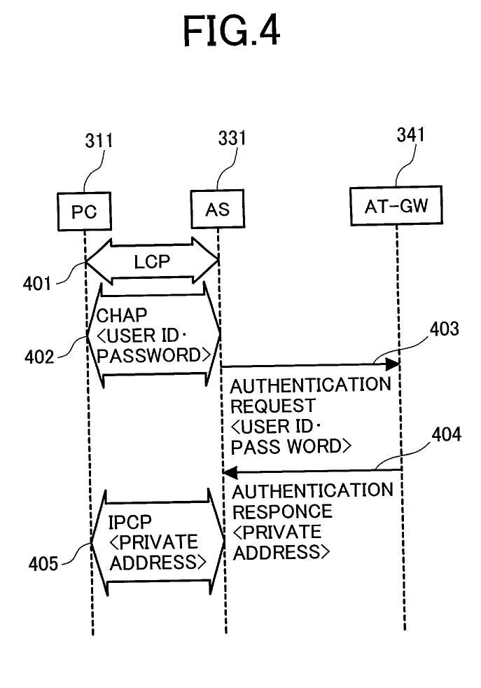

FIG. 4 shows a user's sequence for connecting a system that realizes the service providing method of the present invention. In this case, the PC 311 communicates with both AS 331 and AT-GW 341 as follows.

At first, the PC 311 communicates with the AS 331 by using the Link Control Protocol (LCP) (step 401). Consequently, a data link is established between the PC 311 and the AS 331. After that, the AS 331 receives a user ID and a password from the PC 311 by using such an authentication protocol as a Challenge Handshake Authentication Protocol (CHAP), etc. (step 402). Then, the AS 331 sends the received user ID and password to the AT-GW 341 and issues an authentication request to the AT-GW 341 (step 403). When the user is authenticated by the user ID and the password in response to the authentication request, the AT-GW 341 sends an authentication response and a private address to be assigned to the user to the AS 331 (step 404). The AS 331 sends the received private address to the PC 311 by using the Internet Protocol Control Protocol (IPCP) (step 405). At the same time, the AS 331 communicates the address of the local DNS server 344 used as a Domain Name System server. The PC 311 is thus connected to the system.

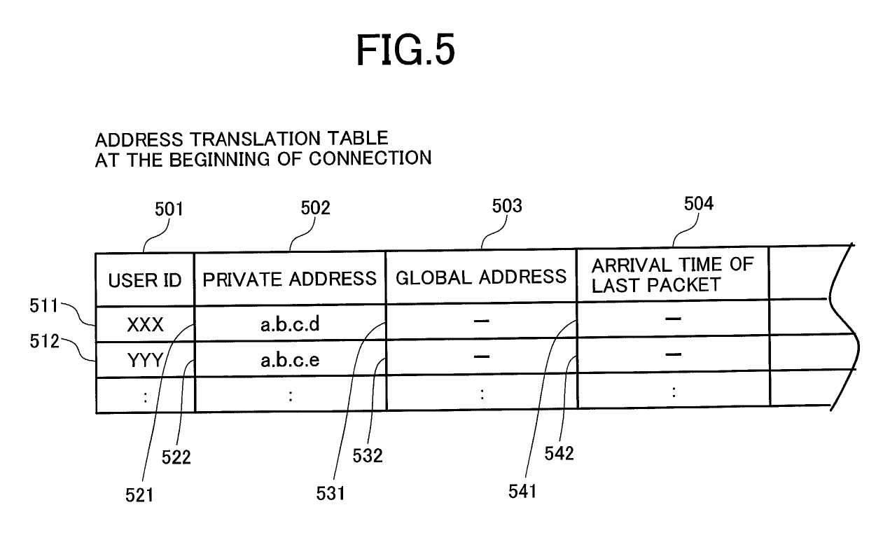

The AT-GW 341 holds an address translation table used to translate addresses. FIG. 5 shows an example of the address translation table used when the PC 311 connects this system. This address translation table includes items of user ID 501; private address 502; global address 503; arrival time of last packet 504, etc. In this example, a user whose ID is XXX is connected to a user whose ID is YYY. In the first record, a user ID “XXX” 511, a private address “a.b.c.d” 512, a global address “null” 531, and an arrival time of last packet “null” 541 are registered respectively. Because “null” is registered in both of the global address and arrival time of last packet fields, the user whose ID is “XXX” is not connected to any ISP yet. The table items to be registered after the user is connected to an ISP will be described later. In the same way, in the second record, a user ID “YYY” 512, a private address “a.b.c.e” 522, a global address “null” 532, and an arrival time of last packet “null” 542 are registered respectively.

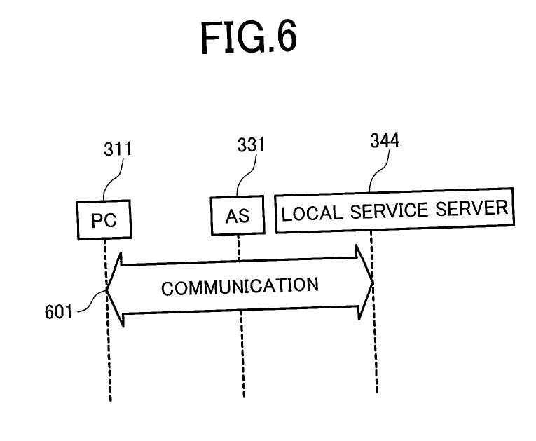

FIG. 6 shows how communication goes between the PC 311 and the local service server 344. After the completion of the connection sequence shown in FIG. 4, the user's PC 311 uses the private address assigned to itself to communicate with the local service server 344 to which a private address is already assigned. At this time, the PC 311 communicates with the local service server 344 via the AS 331 (step 601).

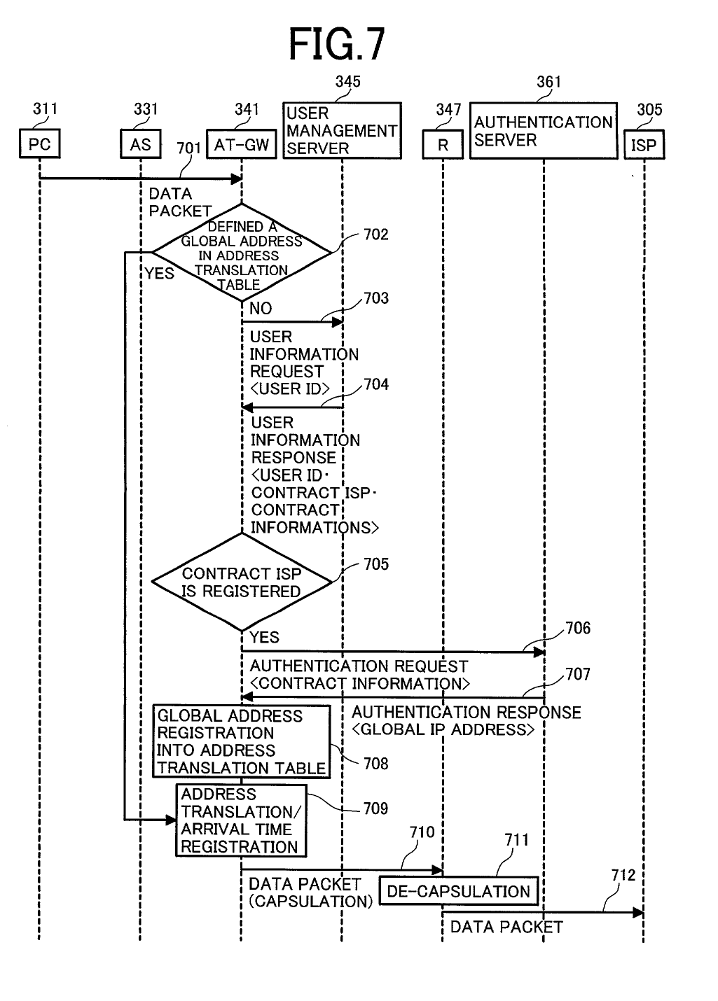

FIG. 7 shows a connection sequence between the PC 311 and an ISP via the Internet. A communication packet sent from the PC 311 via the AS 331 is received by the AT-GW 341 (step 701). This is because both of the AS 331 and the router 346 shown in FIG. 3 are set up so that respective communication packets having a global address are transferred to the AT-GW 341. Receiving a communication packet, the AT-GW 341 searches in the address translation table shown in FIG. 5 so as to decide whether or not a global address is defined for the private address described in the packet source field by using the address described in the packet source field as a key. When a global address is defined, it denotes that the ISP connection is completed. Thus, the AT-GW 341 performs an address translation (step 709) to translate the private address to an address assigned from the ISP. When no global address is defined, it denotes that the ISP connection is not completed yet. Thus, the AT-GW 341 must receive a global address from the ISP before performing the address translation (step 709). The AT-GW 341 then searches the user ID according to the source address used as a key and sends the user ID obtained from the address translation table shown in FIG. 5 to the user management server 345 and requests user information required to know the contract information between the user and the ISP (step 703). The user management server 345, when receiving the user ID, searches the user information that includes the user contracted ISP, the user ID and ISP password registered for the ISP according to the user ID used as a key and sends back those searched information items to the AT-GW 341 (step 704).

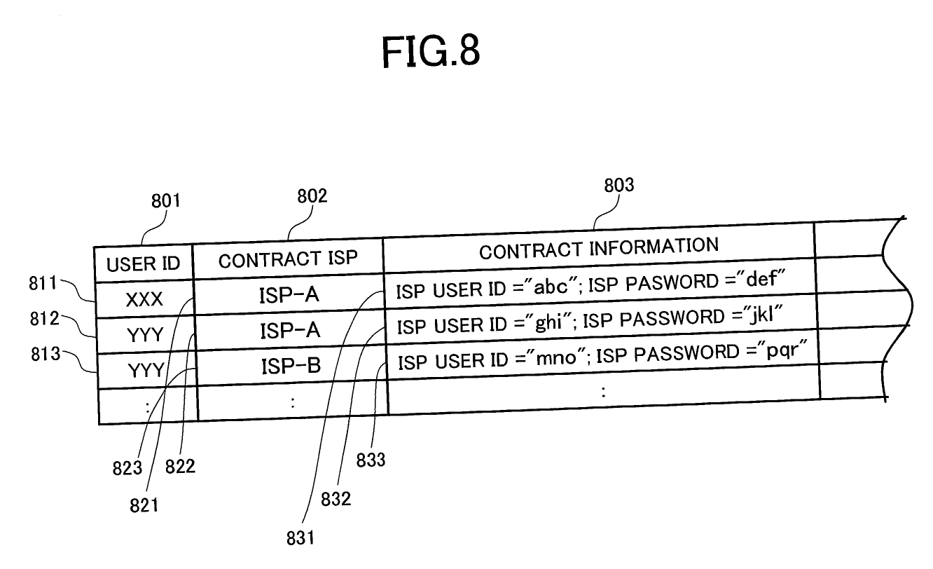

FIG. 8 shows a user information contract table registered in the user management server 345. The items registered in this table are user ID 801; contract ISP 802; contract information 803, etc. In this example, three items are registered in the table. The first record contains a user ID “XXX”, which is “XXX811”, a contract ISP, which is ISP-A 821, and contract information, which is ISP user ID=“abc” and an ISP password=“def” in this example. Those information items are sent back to the AT-GW 341 as a user information response (step 704). Sometimes, the same user has plural records in the table. The second and third records are such an example. In those records, “YYY” is registered in both fields 812 and 813 as a user ID and “ISP-A” 922 and ISP-B 922 are registered as contract ISPs. In the field 932, ISP user ID=“ghi”; ISP password=“jkl” are registered as the information of the user's (user ID: YYY) contract with the ISP-A. In the field 933, ISP user ID=“mno”; ISP password=“pqr” is registered as the information of user's (user ID: YYY) contract with the ISP-B.

Knowing that the user has a contracted ISP from those information items, the AT-GW 341 sends contract information such as the ISP user ID, the ISP password, etc. to the ISP authentication server 361 and requests the server 361 to authenticate the user by using such a protocol as the RADUS (Remote Authentication Dial-In User Service) or the like (step 706). When the authentication is completed correctly, the authentication server 361 assigns a global address and reports it to the AT-GW 341 (step 707) . The AT-GW 341 then registers the assigned global address in the address translation table (step 708) . This completes the connection to the ISP.

After the completion of the ISP connection, the AT-GW 341 performs address translation for the received packet and registers the current time as the arrival time of the last packet (step 709), then capsulates the received data communication packet, which is thus sent out via the target ISP (step 710). The capsulated packet is decapsulated in the router 347 disposed just before the ISP (step 711) and arrives in the ISP as a normal packet (step 712).

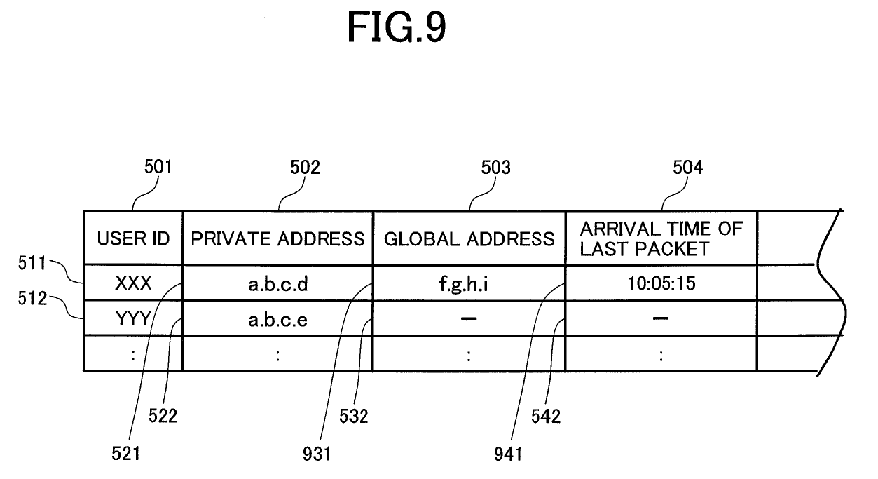

FIG. 9 shows how the processings are done with respect to the address translation table. In FIG. 9, the state of the table shown in FIG. 5 is changed as follows. The global address, which has been a null 531, is changed to “f.g.h.i” 831 and the arrival time of last packet, which has been a null 541, is changed to, for example, 10:5:15 841, which denotes an address translation time respectively in the record of the user whose ID: XXX. The example denotes that the user's connection to the ISP is completed, since a global address and an arrival time of the last packet are registered such way.

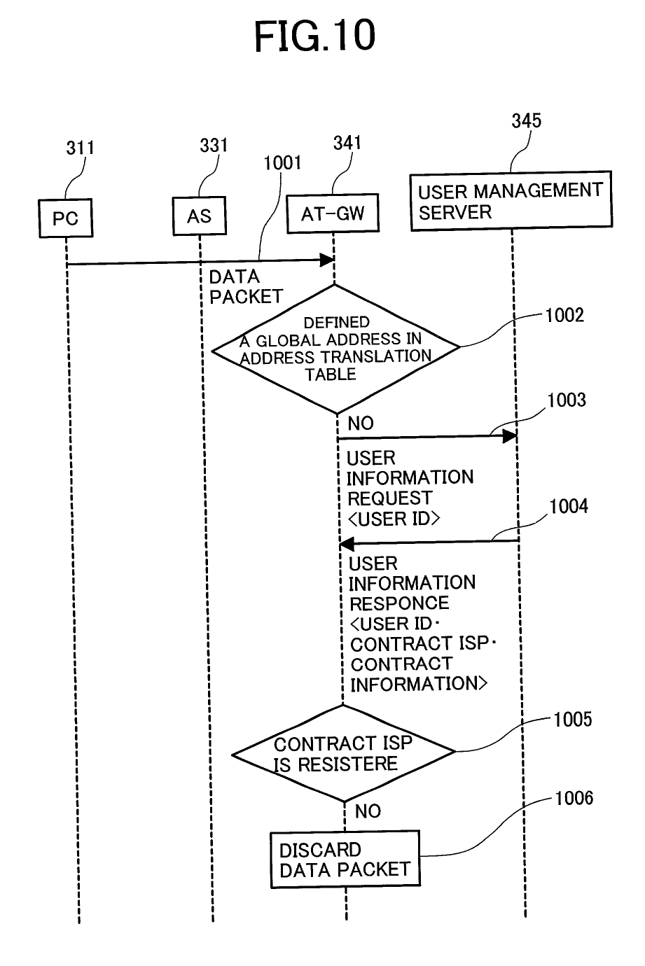

FIG. 10 shows a communication sequence to be performed when the user does not contract with any ISP. At first, the PC 311 sends a packet to the Internet via the AS 331. Because the destination address of the packet is a global address at this time, the packet arrives in the AT-GW 341. The AT-GW 341 then searches in the address translation table by using the source address as a key as described above (step 1002) and finds that no global address is registered in the table. Thus, the AT-GW 341 sends the user ID and issues a user information request to the user management server 345 (step 1003). Then, a user information response (step 1004) is sent back to the user management server 345. However, because the user does not contract with any ISP, the AT-GE 341 finds the fact from the response (step 1005). The AT-GW 345 knows that the received packet is discarded (step 1006) and the PC 311 cannot connect an ISP due to a connection timeout, since there is no ISP contracted by the user.

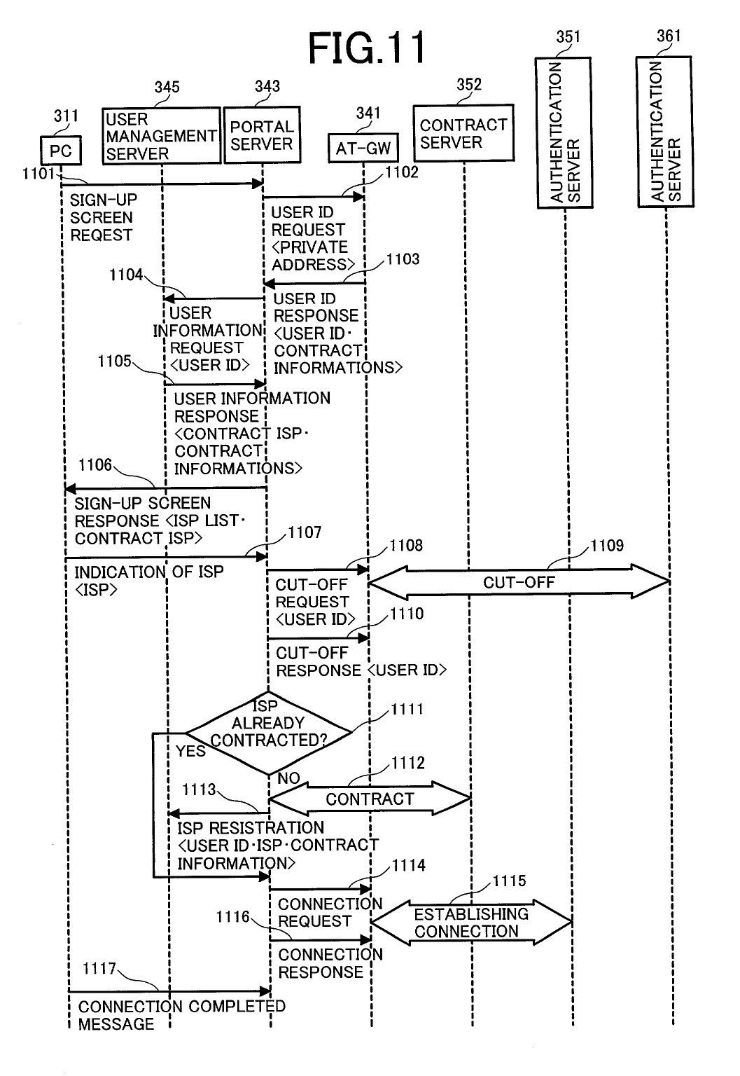

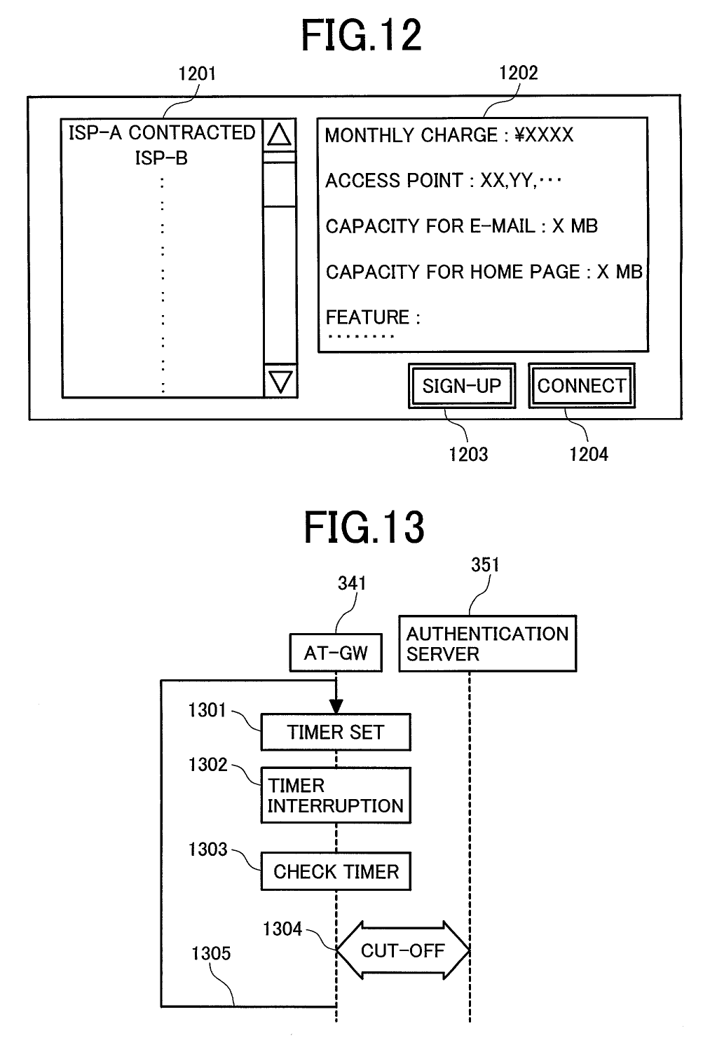

FIG. 11 shows a sequence of communication between the user and the portal server 343. The PC 311 specifies a contract screen URL (Uniform Resource Location) to the portal server 343 and issues a contract screen request with use of the HTTP (Hyper Text Transfer Protocol) (step 1101). Then, the portal server 343 starts up the GCI (Common Gateway Interface) and a JAVA servelet to execute the following operations. At first, the portal server extracts the network address of the PC 311 from the received packet and sends the address to the AT-GW 341 to request the user ID (step 1102). The AT-GW 341 searches the user ID by using the received address as a key and sends the found user ID and connection information that denotes presence of a connection to an ISP to the portal server 343 (step 1103). Receiving the user ID, the portal server 343 sends the user ID to the user management server 345 to request information of contract ISP (step 1104). The user management server 345 then checks each record in the user contract information table shown in FIG. 8 by using the user ID as a key and sends the contract ISP and the contract information to the portal server 343 (step 1105). The portal server 343 generates a web page according to those information items and sends the screen as shown in FIG. 12 to the PC 311.

In FIG. 12, reference numeral 1201 denotes a list of states of contract with selectable ISPs. Reference numeral 1202 denotes a field for denoting information of an ISP selected in the field 1201. Reference numeral 1203 denotes a button used to contract with the selected ISP. Reference numeral 1204 denotes a button used to connect the selected ISP. The user can select an ISP, connect the ISP, and contracts with the ISP on this screen.

FIG. 11 also shows a sequence to be continued for the connection to a selected ISP. The user of the PC 311 presses the button 1203 or 1204 shown in FIG. 12 to send a connection ISP command 1107 with use of the HTTP from the PC 311. The portal server 343, when the PC 311 connects an ISP according to the information received in step 1103, sends the user ID and a disconnection processing request to the AT-GW 341 (step 1108). Receiving the request 1108, the AT-GW 341 performs a disconnection processing from the authentication server in the ISP (step 1109) to disconnect the user from the ISP. After that, the AT-GW 341 sends back a disconnection processing response that denotes completion of the disconnection 1110 to the portal server 343. Then, the portal server 343 decides whether or not the ISP specified by the user according to the connection ISP command 1107 is contracted from the user information obtained in step 1105 (step 1111). When the user specified ISP is already contracted, the AT-GW 341 requests a connection (step 1114). When the user does not contract with the specified ISP, the contract must be done first. The portal server 343 then communicates with the contract server 352 in step 1112 to prompt the user to contract with the specified ISP. After the completion of the contract processing (step 1112), the portal server 343 sends the user ID, the contracted ISP, and the contract information to the user management server 345, then sends additional ISP registration items as new records (step 1113). After that, the portal server 345 issues a connection request that includes the user ID, the ISP, and the contract information to the AT-GW 341 (step 1114). Receiving the request, the AT-GW 341 performs a processing of connection to the authentication server 351 (step 1115). After the completion of the connection (step 1115), the AT-GW 341 sends back a connection response 1116 to the portal server 343 to denote the completion. Receiving the report, the portal server 343 sends a connection completion message to the PC 311 (step 1117). Hereinafter, the PC 311 can communicate with the Internet via the contract ISP.

FIG. 13 shows a sequence for automatical disconnection of an ISP. The AT-GW 341 keeps the operation of a process that monitors the address translation table. In this process, a timer is set at first (step 1301). When a set time is reached, a timer interruption (step 1302) starts up the process. Then, in step 1303, the process compares the arrival time of the last packet shown in step 941 in FIG. 9 with the current time. When there is any record still existing in a certain time after the user sends the last packet, the process disconnects the ISP described in the record with use of the RADIUS protocol. After that, the process returns to the processing in step 1301. Consequently, the ISP is disconnected automatically in a certain time after the communication stops whether it is requested or not.

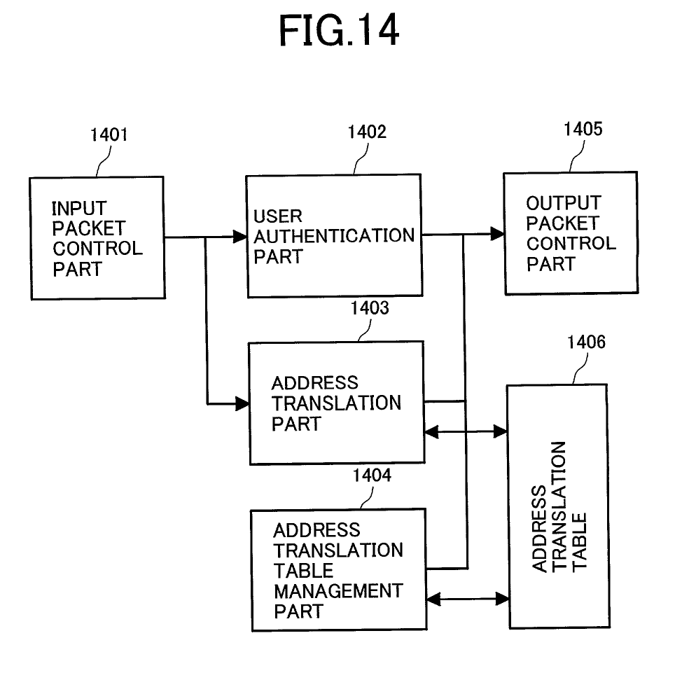

FIG. 14 shows a configuration of software programs used to realize the AT-GW 341 of the present invention. The AT-GW 341 is composed of an input packet control part 1401; a user authentication part 1402; an address translation part 1403; an address translation table management part 1404; an output packet control part 1405; and an address translation table 1406.

The function of the input packet control part 1401 is generally supplied from an operating system (OS). The function controls whether to pass input packet data to a process according to the destination address and the port number of the TCP (Transmission Control Protocol).

The user authentication part 1402 is provided with a function for receiving an authentication request 403 shown in FIG. 4 from the AS 331 via the input packet control part 1401 and sending an authentication response 404 to the AS 331 via the output packet control part 1405.

The address translation part 1403 receives a communication packet 701 from the PC 311 as shown in FIG. 7 and searches whether or not a global address is defined for the packet 701 in the address translation table (step 702). When no global address is defined, the address translation part 1403 obtains the user information as shown in steps 703 and 704. When the PC 311 has a contract ISP, the address translation part 1403 communicates with the authentication server 361 as shown in steps 706 and 707 to register a global address in the address translation table (step 708) and translates the packet address (step 709), then capsulates the packet and sends it to the PC 311 (step 710).

The address translation table management part 1404 is provided with a function for checking the address translation table periodically and disconnecting an ISP when the communication between the ISP and the user stops for more than a certain time translation as shown in FIG. 13.

The output packet control part 1405 is provided with a function for receiving a communication packet to be transferred to another computer from the address translation table management part 1404. Generally, this function is supplied from an OS.

The address translation table 1406 is the same as those shown in FIGS. 5 and 9.

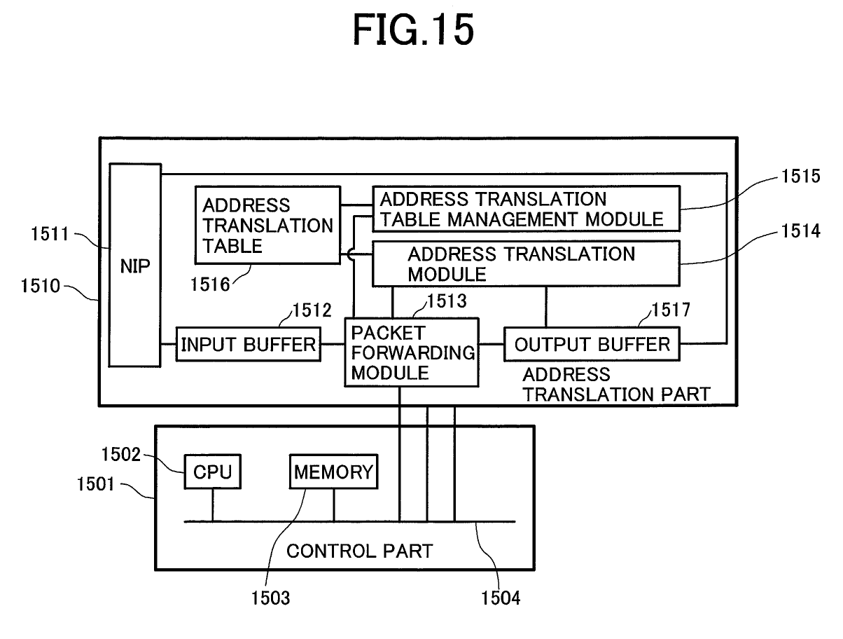

FIG. 15 shows a block diagram of this AT-GW 341 of which address translation function is realized by a hardware item. The AT-GW 341 is roughly divided into a control part 1501 and an address translation part 1502.

The control part includes a CPU (Central processing Unit) 1502 and a memory 1503. Those items are connected to each other via a bus 1504. The bus is also connected to the address translation part 1510.

The address translation part 1502 is composed of the following modules. Reference numeral 1511 denotes a NIF (Network InterFace) used to receive packets. The NIF 1511 performs sending/receiving processings to dispose packets received from a network line in an input buffer 1512 and read packets from an output buffer 1517 so as to send them via the network line. The input buffer 1512 is a storage area used to hold packet data received by the NIF 1511. Reference numeral 1513 denotes a packet transfer module. The packet transfer module 1513 is provided with a function that reads packet data held in the input buffer 1512 to transfer it to the control part 1501 when it is addressed to the AT-GW 341 itself and transfer it to the address translation module 1514 when it is another packet. The packet transfer module 1513 is also provided with a function that transfers a packet received by the control part 1501 to the output buffer 1517. Reference numeral 1514 denotes an address translation module that translates the address of a packet transferred from the packet transfer module 1513. This address translation module 1514 refers to the address translation table 1516 to translate both source and destination network addresses of each received packet. After the translation of those network addresses of a packet, the address translation module 1514 disposes packet data in the output buffer 1517. Reference numeral 1515 denotes a module for managing the address translation table. Just like the module shown in FIG. 14, the address translation management module 1515 is provided with a timer setting function 1301, a timer interruption function 1302, and a passing time checking function. Reference numeral 1516 denotes a storage area for storing each of the address translation tables shown in FIGS. 5 and 9. The address translation module 1514 updates this area as needed. Reference numeral 1517 denotes an output buffer. This output buffer 1517 is used to by the packet transfer module 1513 and the address translation module 1514 to store packet data. Packet data read by the NIF 1511 and sent out is deleted from this area.

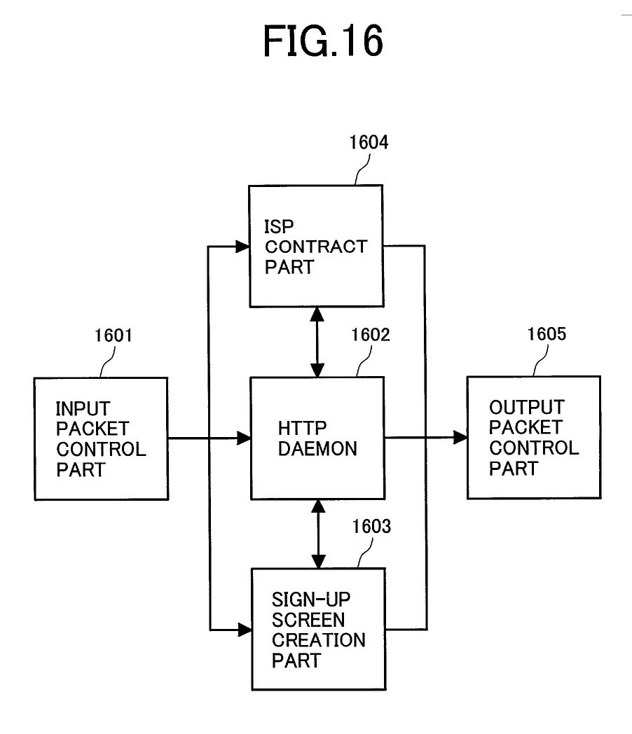

FIG. 16 shows a configuration of software programs used to realize the portal server 343 of the present invention. The portal server 343 is composed of an input packet control part 1601; an HTTP demon 1602; a sign-up screen creation part 1603; an ISP contract part 1604; and an output packet control part 1605.

Generally, the function of the input packet control part 1601 is supplied by an operating system (OS). The input packet control part 1601 is provided with a function for controlling decision of a process to which input packet data is to be passed according to the port number of the TCP (Transmission Control Protocol). The HTTP demon 1602 is provided with a function for receiving a web page request with use of the HTTP and sending the contents of the web page with use of the HTTP. The HTTP demon 1602 is provided with a function for starting up the sign-up screen creation part 1603 when receiving a sign-up screen request shown in FIG. 12 from a user, as well as a function for starting up the ISP contract part 1604 to send the connection completion message shown in step 1114.

The sign-up screen creation part 1603, as shown in FIG. 11, is provided with a function that obtains an user ID from the AT-GW 341 by using a network address as a key (step 1102/1103), then obtains a contract ISP and contract information from the user management server 345 according to the user ID used as a key, then creates a sign-up screen to be sent to the user and sends the created screen to the HTTP demon 1602.

The ISP contract part 1604, as shown in FIG. 11, is provided with functions used to disconnect the current ISP, check the contract ISP (step 1108), contract an ISP (step 1109), registers the ISP in the user management server 345 (step 1110), send a connection request to the AT-GW 341 (step 1111), receive a connection response (in step 1113), and send a connection completion message to the PC 331.

The output packet control part 1605 is provided with functions used to receive communication packets from the HTTP demon 1602, the sign-up screen creation part 1603, and the ISP contract part 1604 and sends the packets to another computer, as well as to control buffering, etc. Generally, these functions are supplied by the running OS.

The data communication service providing method of the present invention enables each user to up-load his/her PC's private address and down-load a global address from a target ISP. The method also provides each user with an address translation gateway (AT-GW) used to translate the private address so that both addresses are related to each other, as well as with a GUI used by the user to select a target ISP. Consequently, a portal server that transfers each user's request for the connection to a target ISP to a NAT server and a user management server that holds an ISP with which each user contracts and the contract information cooperate together.

According to the present invention, therefore, a communication enterprise can let a user use his/her PC's private address when in communicating and receiving a local service therefrom and translate the private address to a global address with use of the AT-GW so as to enable the user to communicate and receive a service on the Internet or both of the local service and the service on the Internet.

According to the data communication service providing method of the present invention, each user is provided with the GUI for selecting an ISP in a portal server, so that each communication enterprise can provide each user with a criterion for selecting an ISP, thereby the user can select the ISP; the user is not required to make any contract with the enterprise about the selected ISP nor set up the connection to the selected ISP in the user's terminal.

We claim

1. A method for providing a data communication service, which enables a user computer to be connected to an Internet service provider via a network and communication between said user computer and said Internet service provider to be established, said method comprises;
a step of holding a first network address assigned to said user computer from said Internet service provider and translating a second network address sent from said user computer to said first network address; and
a step of establishing communication between said user computer and said Internet service provider.

2. The method for providing a data communication service according to claim 1;
wherein said method further includes:
a step of allowing said network to give said second network address to said user computer;
a step of allowing said network to hold a user ID used to identify said user computer and said second network address so that both items are related to each other;
a step of allowing said network to issue a user authentication request to said Internet service provider; and
a step of allowing said network to hold said first network address assigned to said user computer from said Internet service provider.

3. The method for providing a data communication service according to claim 1;
wherein said user ID, said first network address, and said second network address are held so that they are related to each another.

4. The method for providing a data communication service according to claim 1;
wherein said second network address sent from said user computer is an address described in a network address field in a communication packet.

5. The method for providing a data communication service according to claim 1;
wherein said communication between said user computer and said Internet service provider is established according to said first network address while said communication between said user computer and a server is established according to said second network address.

6. An address translation apparatus connected to plural user computers and plural Internet service providers via a network, said apparatus being used to communicate with an authentication server installed in a network of an Internet service provider to authenticate a user when a connection request is issued from a user computer to said Internet service provider, store a network address assigned to said user computer, translate at least one of source and destination network addresses described in a field in a communication packet, and transfer said translated network address;
wherein a network address assigned to each user computer and a network address assigned to said user computer from an Internet service provider that has received a connection request from said user computer makes a pair and said address translation apparatus holds said pair of network addresses, so that said apparatus, when receiving a packet that describes one of said held paired network addresses, translates one of said held paired network addresses, then transfers said translated network address.

7. A network for connecting a user computer to an Internet service provider;
wherein said network holds user identification information used to identify said user computer, a private address assigned to said user computer from said network, and a global address assigned to said user computer from said service provider.

8. The network according to claim 7;
wherein said global address is used to access said Internet service provider and said private address is used to access a server in said network.

9. The network according to claim 8;
wherein said private address is translated into said global address to access said Internet service provider.

10. The network according to claim 7;
wherein said network includes:
an address translation gateway provided with a table for holding a set of user identification information used to identify said user computer, a private address assigned to said user computer from said network, and a global address assigned to said user computer from said Internet service provider; and
an access server for requesting said address translation gateway for said private address upon receiving said user identification information and a password from said user computer.
